(19) United States
(12) Patent Application Publication
(10) Pub. No.: US 2007/0011176 A1
(43) Pub. Date: Jan. 11, 2007

(54) Business reporting under system failures

(76) Inventor: Prasad R. Vishnubhotla, Round Rock, TX (US)

Correspondence Address: Greg Goshorn, P.C., 9600 Escarpment, auite 745-9, AUSTIN, TX, 78749, US

(21) Appl. No.: 11/174,965

(22) Filed: Jul. 5, 2005

(51) Int. Cl. G06F 7/00

(52) U.S. Cl. 707/100

(57) ABSTRACT

Provided is a method of business reporting in which information is not assumed to be one hundred percent (100%) accurate. A confidence factor is incorporated into business reporting such that any particular business report includes a calculation of the confidence that the particular information is valid. The confidence factor is a floating point value between zero (0) and one (1), with a value of ‘0’ indicating that the corresponding data cannot be assumed to be reliable and a value of ‘1’ indicating that the data is as reliable as is possible. If there is no confidence factor, then the factor is assumed to have a value of ‘1’ so that unnecessary confidence reporting is avoided. Also provided is means for disabling the confidence factor reporting so that unnecessary processing may be prevented when desired.

### TECHNICAL FIELD

The present invention relates generally to business reporting and, more specifically, to a method of combining business data with a confidence factor.

### BACKGROUND OF THE INVENTION

Business reporting typically utilizes multiple data sources, such as, but not limited to, data warehouses, data marts, online analytical processing (OLAP) cubes and online transaction systems. Business data is displayed to business people at many organizational levels using visual reports with varying degrees of summarized and detailed information. Accurate information is important because business people rely on the information to make business decisions that may have far reaching implications.

Sometimes, the accuracy of information is questioned due to system failures. System failures may include such scenarios as data hosting services going down or becoming overloaded and communication failures. In either scenario, and many other scenarios, a reporting system is not able to access the data necessary to produce accurate reports.

Since data may be reported from multiple sources, it is possible for one or more sources to be unavailable for data extraction. For example, available report data can become inconsistent if order shipment information is up-to-date but order processing information is out-of-date. A report produced from inaccurate data is probably inaccurate as well. An inaccurate report may be useless or even damaging.

One method of handling inaccurate or untimely information is to report system problems to end users and informing the users that particular reports are either unavailable or inconsistent. Accounting and financial reporting system typically employ tools and techniques to create business scorecards. However, business scorecards do not address issues that arise in the event of system failures. Some reporting approximations are even deliberate, e.g. rounding dollar amounts. While this method may be accurate, it is not particularly useful.

What is needed is a method of producing meaningful business information in spite of partial system failures. Such a method would enable a business user to evaluate the reliability of information so that informed business decisions can be made in spite of inaccurate or incomplete data.

### SUMMARY OF THE INVENTION

What is provided is a method of business reporting in which information is not assumed to be one hundred percent (100%) accurate. A confidence factor is incorporated into business reporting such that any particular business report includes a calculation of the confidence that the particular information is valid. The confidence factor is a floating point value between zero (‘0’) and one (‘1’), with a value of ‘0’ indicating that the corresponding data cannot be assumed to be reliable and a value of ‘1’ indicating that the data is as reliable as is possible. If there is no confidence factor, then the factor is assumed to have a value of ‘1’ so that unnecessary confidence reporting is avoided.

The claimed subject matter also provides for the disabling of confidence factor reporting so that unnecessary processing may be prevented when desired. The claimed subject matter enables end users to determine the relative significance of reported information based upon confidence levels. Also provided is a method of examining, or “drilling-down” into, low confidence factors to determine the source of data problems. For example, an end user may make a different decision based upon whether a particular data source is overloaded or simply not reporting. If the end user determines that data might not be lost but rather delayed, a business decision may also be delayed until a time when the information is available.

Statistical methods, which take a small sample from a larger set of data, employ a margin of error calculation. Although common in statistical reporting, this calculation is not used in business reporting. With respect to the claimed subject matter, margin of error is not applicable because the confidence factor is based upon missing or incomplete data rather than data that have been purposely skipped.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description. For example, the choice of confidence level values that vary between ‘0’ and ‘1’ is arbitrary and could easily be implemented differently or even be subject to a parameter set by a user.

### BRIEF DESCRIPTION OF THE DRAWINGS

A better understanding of the present invention can be obtained when the following detailed description of the disclosed embodiments is considered in conjunction with the following drawings.

FIG. 1 is an exemplary business model that employs the claimed subject matter.

FIG. 2 is a block diagram of a computing system introduced in FIG. 1.

FIG. 3 is an External Confidence table employed in the claimed subject matter.

FIG. 4 is an Internal Confidence table employed in the claimed subject matter.

FIG. 5 is flowchart of a Maintain External Confidence (EC) Table process for updating the External Confidence table introduced in FIGS. 2 and 3.

FIG. 6 is flowchart of a Maintain Internal Confidence (IC) Table process for updating the Internal Confidence table introduced in FIGS. 2 and 4.

### DETAILED DESCRIPTION OF THE FIGURES

Although described with particular reference to a business that manufactures and distributes products, the claimed subject matter can be implemented in any business architecture which is subject to information reporting failures. Those with skill in the computing arts will recognize that the disclosed embodiments have relevance to a wide variety of business and computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject matter, is directed to a programmed method for addressing failures in information collection and reporting. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

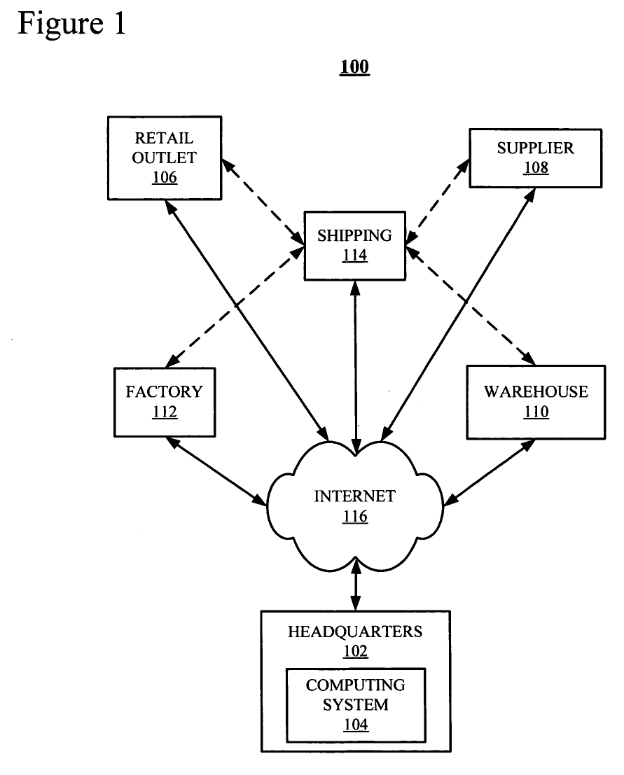

FIG. 1 is an exemplary business model 100 that employs the claimed subject matter. Model 100 is a manufacturing and distribution network for business products. Model 100 is used only as an example; the claimed subject matter may be employed in any type of business scenario. In addition, the specific types of products manufactured and distributed by model 100 are not an essential feature of the claimed subject matter. In FIG. 1, dotted lines represent the movement of products and solid lines represent the movement of information. The claimed subject matter is primarily concerned with the movement of information within model 100 as represented by the solid lines.

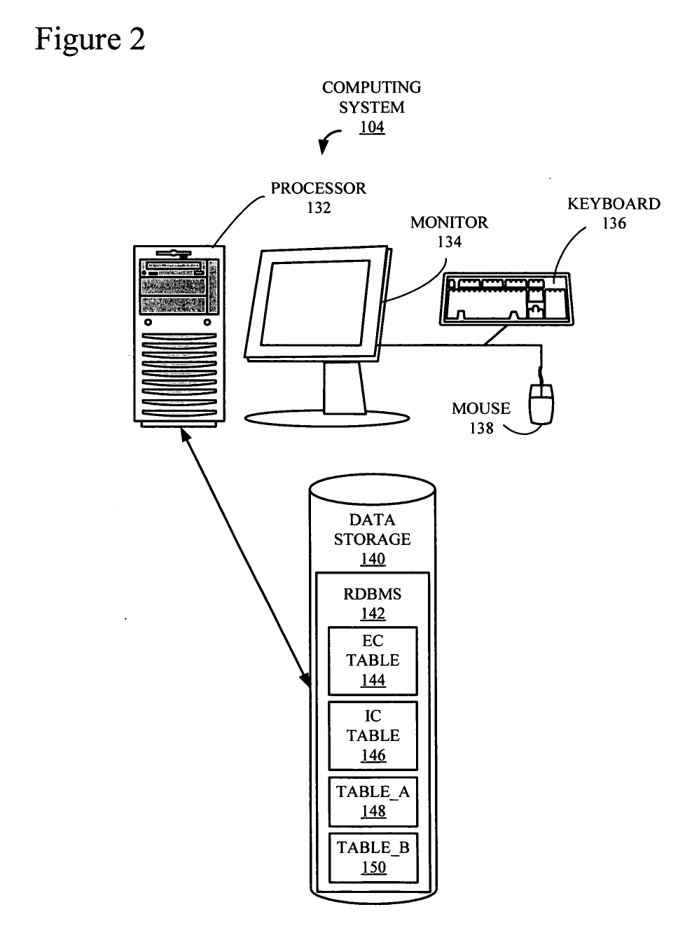

Model 100 includes a headquarters 102 which conducts the operation of business model 100. Headquarters 102 includes a computing system 104, described in more detail below in conjunction with FIG. 2, that supports the collection, procesing and reporting of information from model 100.

Other entities in business model 100 include a retail outlet 106, a supplier 108, a warehouse 110, a factory 112 and a shipping facility or service 114. The specific functions of business entities 106 108, 110, 112 and 114 are self-explanatory, not critical to the spirit of the invention and employed only for the purpose of illustration. Each of business entitles 106 108, 110, 112 and 114 produce various business information and communicate that information to headquarters 102 and computer system 104. In this example, the information is communicated through the Internet 116, although those with skill in the computing and/or communication arts should appreciate that there are many possible means of communication that may be employed together or separately to move information within business model 100.

FIG. 2 is a block diagram of computing system 104, which was introduced in above in conjunction with FIG. 1. Computing system 104 includes a processor, or computer, 132, a monitor 134, a keyboard 136 and a mouse 138. Monitor 134, keyboard 136 and mouse 138 facilitate human interaction with computing system 104.

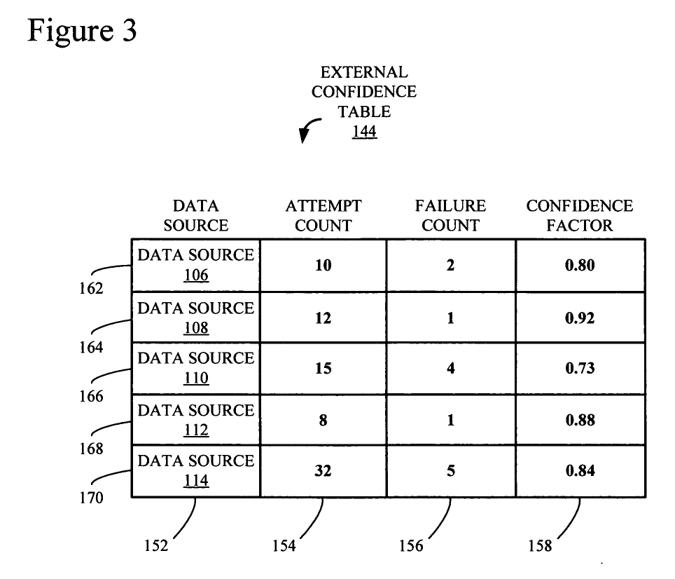

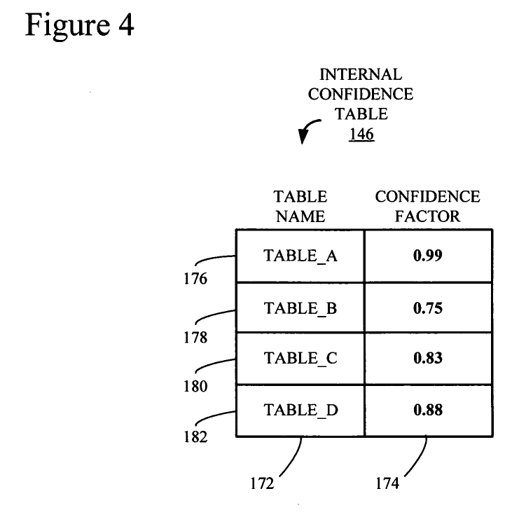

Attached to computer 132 is a data storage component 140, which may either be incorporated into computer 132 i.e. an internal device, or attached externally to computer 132 by means of various, commonly available connection devices such as but not limited to, a universal serial bus (USB) port (not shown). In this example, data storage 140 stores a relational database management system (RDBMS) 142. RDBMS 142 is illustrated with two tables that are applicable to the implementation of the claimed subject matter, an exemplary external confidence (EC) table 144 and an exemplary internal confidence (IC) table 146. EC table 144 is described in more detail below in conjunction with FIG. 3. IC table 146 is described in more detail below in conjunction with FIG. 4. Also include in RDBMS 142 and stored on data storage 140 are a Table_A 148 and a Table_B 150. Tables 148 and 150 are only used for the purpose of illustrating the claimed subject matter and store typical business data related to business model 100 (FIG. 1).

Although the illustrated implementation of the claimed subject matter employs RDBMS 142 and exemplary tables 148 and 150 those with skill in the art should appreciate that there are many equally suitable implementations including other types of data structures for implementing the claimed subject matter, including XML.

FIG. 3 shows EC table 144 (FIG. 2) in more detail. EC table 144 includes four (4) columns: a data source column 152, an attempt count column 154, a failure count column 156 and a confidence factor column 158. Data source column 152 stores information to uniquely identify possible data sources. For example, a row 162 is illustrated representing information relating to retail outlet, or data source, 106 (FIG. 1). A row 164 is illustrated representing information relating to supplier, or data source, 108 (FIG. 1). A row 166 is illustrated representing information relating to warehouse, or data source, 110 (FIG. 1). A row 168 is illustrated representing information relating to factory, or data source, 112 (FIG. 1). A row 170 is illustrated representing information relating to shipping service, or data source, 114 (FIG. 1). A typical business would have many more data sources than model 100 and therefore many more rows in table 144. In other words, addition data sources would each have their own row in table 144.

Attempt count column 154 stores information relating to the number of times computing system 104 (FIGS. 1 and 2) has attempted to access the corresponding data source 106, 108, 110, 112 or 114. In this example, since the beginning of the sampling period, computing system 104 has polled data source 106 a total of ten (10) times; polled data source 108 a total of twelve (12) times; polled data source 110 a total of fifteen (15) times; polled data source 112 a total of eight (8) times; and polled data source 114 a total of thirty-two (32) times. Of course, the specific number of times a particular data source 106, 108, 110, 112 or 114 has been polled has been selected arbitrarily for the purposes of illustrating the claimed subject matter. Of course, data may arrive asynchronously rather than as the result of a polling process.

Failure count column 156 stores information relating to the number of times computing system 102 has failed in an attempt to access the corresponding data source 106, 108, 110, 112 or 114. In this example, since the beginning of the sampling period, computing system 102 has failed to receive data from data source 106 a total of two (2) times; failed to receive data from data source 108 a total of one (1) time; failed to receive data from data source 110 a total of four (4) times; failed to receive data from data source 112 a total of one (1) time; and failed to receive data from data source 114 a total of file (5) times. Of course like with respect to attempt count 154, the specific number of times a particular data source 106, 108, 110, 112 or 114 has failed to receive data has been selected arbitrarily for the purposes of illustrating the claimed subject matter.

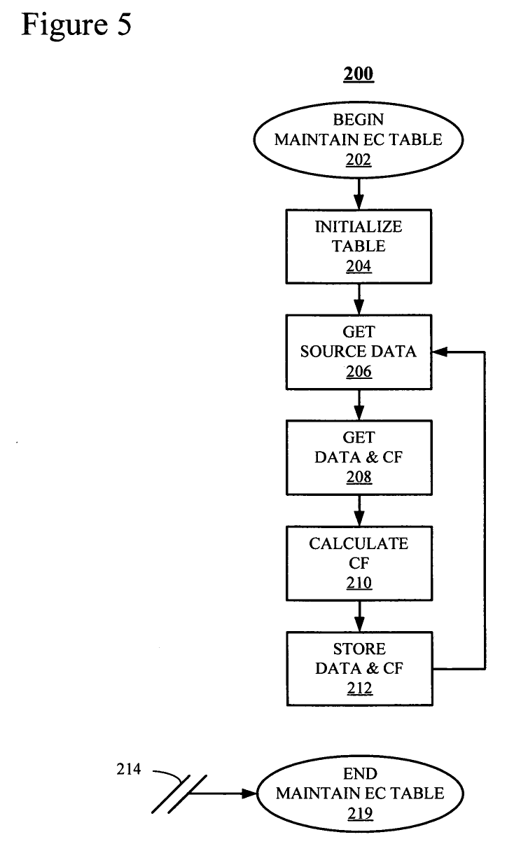

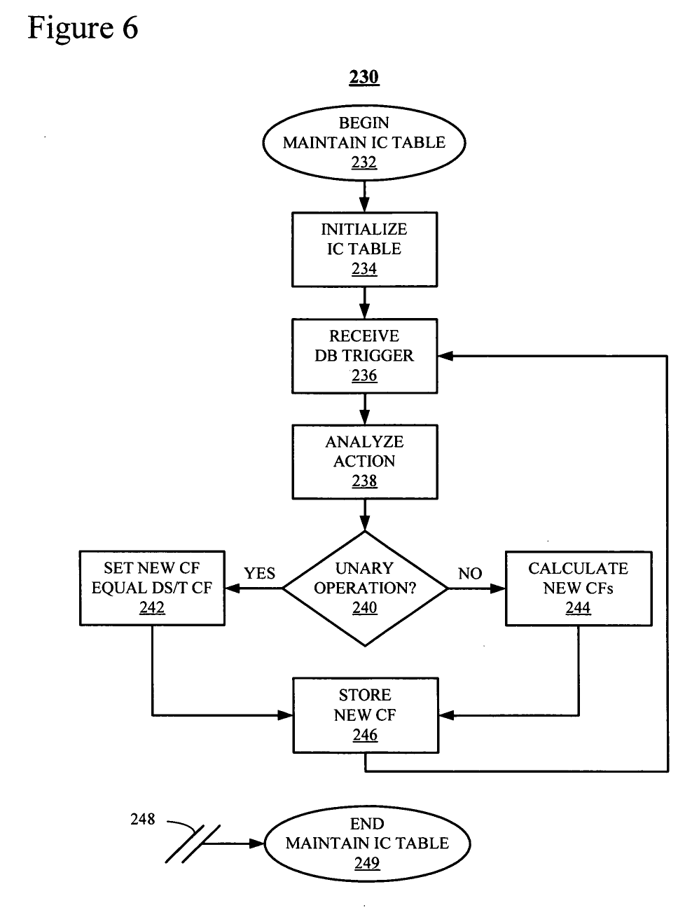

Confidence factor column 158 stores a calculation of a ratio of the number of successful data attempts by a corresponding data source 106, 108, 110, 112 or 114 to the number of attempts, stored in column 156. The number of successful attempts is calculated by subtracting the number of failed attempts, stored in column 156, for the number of attempts to access a particular data source 106, 108, 110, 112 or 114. For example in this illustration, the confidence factor of data source 106 is equal to ‘0.80’, the confidence factor of data source 108 is equal to ‘0.92’, the confidence factor of data source 110 is equal to ‘0.73’, the confidence factor of data source 112 is equal to ‘0.88 and the confidence factor of data source 114 is equal to ‘0.84. In other words, during the sampling period, the data access success rate of data source 106 was eighty percent (80%), the data success rate of data source 108 was ninety-two percent (92%), the data success rate of data source 110 was seventy-three percent (73%), the data success rate of data source 112 was eighty-eight percent (88%) and the data success rate of data source 114 was eighty-four percent (84%). Exemplary calculations employed to arrive at the values stored in column 158 are explained in more detail below in conjunction with FIGS. 5 and 6.

It should be obvious to those with skill in the computing arts that confidence factor column 158 is not strictly necessary in that the stored data could be calculated from the data in columns 154 and 156 each time the data is requested. Whether or not to store the confidence factor information is a tradeoff between processing and memory resources that is typically made by the designers of the system and depends, in part, upon the number of times the data is accessed vs. the number of times the data is updated.

FIG. 4 shows IC table 146 (FIGS. 1 and 2) of RDBMS 112 (FIGS. 1 and 2) in more detail. IC table 146 includes two (2) columns: a table name column 172 and a confidence factor column 174. Table name column 172 stored information to uniquely identify table within RDBMS 112. For example, a row 176 is illustrated representing information relating to table_A 148 (FIG. 2). A row 178 is illustrated representing information relating to table_B 150 (FIG. 2). A row 180 is illustrated representing information relating to a table_C (not shown) and a row 182 is illustrated representing information relating to a table_D (not shown) of RDBMS 112.

Like confidence factor column 158, which stores information relating to the calculated reliability of the corresponding data source 106, 108, 110, 112 or 114, confidence factor column 174 stores information relating to a calculated reliability for the corresponding table, e.g. table_A 148, table_B 150, table_C and table_D. The value of any particular confidence factor in column 174 may depend upon multiple data source confidence values of confidence factor column 158 (FIG. 4) of external confidence table 144 (FIG. 4). One exemplary process for arriving at values for confidence factor column 174 are explained in more detail below in conjunction with FIGS. 5 and 6.

FIG. 5 is flowchart of a “Maintain External Confidence (EC) Table” process 200 for updating external confidence table 144 introduced in FIGS. 2 and 3. Process 200 starts in a “Begin Maintain EC Table” block 202 and control proceeds immediately to an “Initialize Table” block 204. During block 204, process 200 sets the values in attempt count column 154, failure count column 156 equal to ‘0’ to indicate that no data has yet been recorded. The values in confidence factor column 158 are set equal to ‘1’ indicating that, at least at the beginning of the sampling period, we have complete confidence in the corresponding data source. Of course, the initial values of column 158 may also be set equal to ‘0’ to indicate that a data source is not considered reliable unless data has actually been received. In other words, the initial values of confidence factor column 158 may be established by a system administrator based upon direct knowledge of model 100. In fact, some data sources may be initialized with a confidence value equal to ‘1’, some with a value equal to ‘0’ and some with a value that is in between ‘0’ and ‘1’. Although confidence values may be set within any range of numbers, the rational of setting them within a range of ‘0’ to ‘1’ becomes clearer below.

When the system of the claimed subject matter is first installed on computing system 104, the values of data source column 152, and therefore, in this example, rows 162, 164, 166, 168 and 170 are entered by a system administrator familiar with the particular data sources of the current business model. In the alternative, the values of column 152 may be entered via a configuration file or entered as the result of a scan process that examines model 100 for the available resources. It should be noted that in an ideal setup of the system, no data should enter the claimed system unless there is a corresponding entry, or row, in external confidence table 144 for the source of that data.

Process 200 proceeds to a “Get Source Data” block 206 during which the claimed system waits for data corresponding to a data source listed in external confidence table 144 to be received by computing system 104. It should be noted that the data received from a particular data source may be an indication that an attempt to access the data source was unsuccessful.

Once data, either valid data or an indication of a failure, has been received, control proceeds to a “Get Data and CF” block 208 during which process 200 retrieves the data form external confidence table 144 that corresponds to the row of the source of the received data.

Control proceeds to a “Calculate Confidence Factor (CF)” block 210 during which the system calculates a new value for confidence factor column 158 based upon the history of success or failure of data retrieval attempts for this data source. As explained above in conjunction with FIG. 3, the confidence factor stored in column 158 is based upon the percent of successful data retrieval attempts to total attempts. For example, if that have been ten (10) attempts to collect data and seven (7) of those attempts were successful, then the value of the confidence factor for that particular data source would be equal to ‘0.70’. If the next attempt is successful, then the confidence factor value would increase to ‘0.73’.

Process 200 proceeds to a “Store Data and CF” block 212 during which the confidence factor calculated during block 210 is stored in the appropriate location of confidence factor column 158. Control then returns to Get Source Data block 206 in which process waits for the next available data and processing continues as described above.

Finally, process 200 is halted by means of an interrupt 214, which passes control to an “End Maintain EC Table” block 219 in which process 200 is complete. Interrupt 214 is typically generated when the OS, database, application, etc. of which process 200 is a part is itself halted. During nominal operation, process 200 continuously loops through the blocks 206, 208, 210 and 212, processing data source as they are available.

FIG. 6 is a flowchart of a Maintain Internal Confidence (IC) Table” process 230 employed by the claimed subject matter to keep IC table 146 (FIGS. 2 and 4) up-to-date. Process 230 starts in a “Begin Maintain IC Table” block 232 and control proceeds immediately to an “Initialize IC Table” block 234. Ideally, there should be a row in table 146 for each table in RDBMS 112. The rows can be established when the system is installed or produced as the result of a scan process.

During block 234, each value of confidence factor column 174 are set equal to ‘1’ indicating that, at least at the beginning of the sampling period, we have complete confidence in the corresponding table. Of course, the initial values of column 174 may also be set equal to ‘0’ to indicate that a corresponding table is not considered reliable unless data has actually been received and a confidence value calculated. In other words, the initial values of confidence factor column 174 may be established by a system administrator based upon direct knowledge of model 100 (FIG. 1) and RDBMS 112 (FIGS. 1 and 2). In fact, some tables be initialized with a confidence value equal to ‘1’, some with a value equal to ‘0’ and some with a value that is in between ‘0’ and ‘1’. Although in an alternative embodiment confidence values may be set within any range of numbers, the rational of setting them within a range of ‘0’ to ‘1’ becomes clearer below.

During a “Receive DB Trigger” block 236, process 230 waits for a database trigger generated by an update of EC table 144 or IC table 146, indicating that a data source 106, 108, 110, 112 or 114 or table 148 or 150 has received data and the corresponding confidence factor value of column 158 (FIGS. 2 and 3) or column 174 (FIGS. 2 and 4) respectively has been updated. During an “Analyze Action” block 238, process 230 determines the particular data source 106, 108, 110, 112 or 114 or table 148 or 150 that has been updated and the associated tables 148, 150, etc. that depend upon the updated data source or table.

During an “Unary Operation?” block 240, process 230 determines whether or not the confidence factors 174 that depend upon the updated table are unary operations that only depend upon a single table or data source. If so, process 230 proceeds to a “Set New CF Equal Data Source/Table (DS/T) CF” block 242 during which the new confidence factor is set to the old confidence factor of the data source or table upon which the target confidence factor depends. For example, whenever a unary SQL function such as SUM or MAX is applied to an internal database table and the result is stored in another internal database table, the confidence value of the target table gets the same confidence value as the source table. In a similar fashion, when a table depends solely upon a single data source 106, 108, 110, 112 or 114 the appropriate value of column 174 is set equal the appropriate value of column 158.

If during block 240 process 230 determines that the impacted tables depend upon multiple data source and/or tables, control proceeds to a “Calculate New CF” block 244. In one embodiment, a method of calculating a new confidence factor from multiple sources simply involves multiplying all the relevant confidence factor values together to arrive at a new confidence factor value. Since in this embodiment confidence factor values are between ‘0’ and ‘1’, the new confidence factor value is also between the value of ‘0’ and ‘1’.

In alternative embodiments, more complicated formulas for the calculation of confidence factor values may be employed. For example, component confidence factor values may be weighted on importance or the amount of time since a value was updated. i.e. particular data source or tables are given more importance and old values are given less weight than newer ones.

Following blocks 242 and 244, process proceeds to a “Store New CF Value” block 246. During block 246, process 230 stores the confidence value calculated in either block 242 or block 244 in the appropriate position in confidence factor column 174. Once a new confidence factor value has been stored, process 230 returns to Receive DB Trigger block 236 to wait for another trigger and processing continues as described above.

Although FIG. 6 only shows the processing necessary if a data change affects one row 176, 178, 180 or 182 of table 146, of course a data change may affect multiple rows. In such a case, process 230 would loop through blocks 238, 240, 242, 244 and 246, perhaps in a recursive fashion, until all relevant rows and all dependencies have bee accounted for.

Finally, process 230 is halted by means of an interrupt 248, which passes control to an “End Maintain IC Table” block 249 in which process 230 is complete. Interrupt 248 is typically generated when the OS, database, application, etc. of which process 230 is a part is itself halted. During nominal operation, process 230 continuously loops through blocks 236, 238, 240, 244 and 246 processing data changes as they occur.

In one embodiment, computer system 104 (FIGS. 1 and 2) provides a graphical user interface (GUI) for accessing the confidence factor information stored in tables 144 and 146. For example, reports are produced that, when displayed on monitor 134 (FIG. 2) enable a user to use mouse 138 (FIG. 2) to “drill into” information in table 146 and display related information on which any particular information is based. This facility enables the user not only to gage the accuracy of particular information but to research the possible sources of unreliable information. In this manner, more informed business decisions can be made.

Although the claimed subject matter is illustrated with a system that defines a confidence value at the granularity of tables. Additional memory resources could be allocated to extend the system to define values at the granularity of columns, rows or even table elements. Of course, each increase in granularity brings a corresponding increase in memory requirements. Since maintaining confidence values for columns is independent of the amount of data within a table, CF information can be maintained in a system catalog as metadata. To maintain CF information for rows or at an element level requires that each row or element have a corresponding memory location for storing the information.

There are also methods of approximating confidence factor values at a greater granularity than the stored information itself. For example if confidence factors are maintained at a row and column level of granularity, whenever an element is added or updated, the confidence factor of a column is set equal to MIN(Old, New) where “Old” is the previous confidence factor for the column and “New” is the newly calculated confidence factor. In another embodiment, a confidence factor is maintained for rows by storing a special confidence factor column for each table. If a confidence factor is maintained for each row and column, a confidence factor for an element can be approximated by calculating the product of the row and column confidence factors for the particular element.

In an online analytical processing (OLAP) environment, confidence factor values can be defined for cubes and/or sub-cubes. This enables an analyst to focus attention on high-confidence sub-cubes when necessary.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for reporting business data, comprising:
collecting a first set of data associated with a business process;
calculating a first confidence factor associated with the first set of data, wherein the first confidence factor is based upon a success rate corresponding to the collection of the first set of data;
storing the first set of data and the first confidence factor in a memory; and
reporting the first confidence factor in conjunction with the first set of data.

2. The method of claim 1, wherein the success rate is based upon the availability and completeness of the first set of data.

3. The method of claim 1, further comprising:
recalculating the first confidence factor upon the collection of new data associated with the first set of data; and
storing the new data and the recalculated first confidence factor.

4. The method of claim 1, further comprising:
collecting a second set of data associated with the business process;
calculating a second confidence factor associated with the second set of data, wherein the second confidence factor is based upon a success rate corresponding to the collection of the second set of data;
calculating a composite confidence factor associated with business data based upon the first and second confidence factors;
storing the composite confidence factor in the memory; and
reporting the composite confidence factor in conjunction with the business data based upon the first and second set of data.

5. The method of claim 4, wherein the calculating of the composite confidence factor comprises multiplying the first confidence factor and the second confidence factor.

6. The method of claim 4, wherein the calculating of the composite confidence factor comprises setting the value of the composite confidence factor as the lesser of the first confidence factor and the second confidence factor.

7. The method of claim 4, wherein the data is stored by a relational database management system and the first set of data corresponds to a first data table and the second set of data corresponds to a second table.

8. A system for reporting business data, comprising:
a first set of data associated with a business process;
a first confidence factor associated with the first set of data, wherein the first confidence factor is based upon a success rate corresponding to the collection of the first set of data;
logic for storing the first set of data and the first confidence factor in a memory; and
logic for reporting the first confidence factor in conjunction with the first set of data.

9. The system of claim 8, wherein the success rate is based upon the availability and completeness of the first set of data.

10. The system of claim 8, further comprising:
new data associated with the first set of data;
logic for recalculating the first confidence factor upon the collection of new data; and
logic for storing the new data and the recalculated confidence factor.

11. The system of claim 8, further comprising:
a second set of data associated with the business process;
logic for calculating a second confidence factor associated with the second set of data, wherein the second confidence factor is based upon a success rate corresponding to the collection of the second set of data;
logic for calculating a composite confidence factor associated with business data based upon the first and second confidence factors;
logic for storing the composite confidence factor in the memory; and
logic for reporting the composite confidence factor in conjunction with the business data.

12. The system of claim 11, wherein the calculating of the composite confidence factor comprises multiplying the first confidence factor and the second confidence factor.

13. The system of claim 11, wherein the logic for calculating of the composite confidence factor comprises logic for setting the value of the composite confidence factor as the lesser of the first confidence factor and the second confidence factor.

14. The system of claim 11, wherein the data is stored by a relational database management system and the first set of data corresponds to a first data table and the second set of data corresponds to a second table.

15. A computer programming product for reporting business data, comprising:
a memory;
logic, stored on the memory, for collecting a first set of data associated with a business process;
logic, stored on the memory, for calculating a first confidence factor associated with the first set of data, wherein the first confidence factor is based upon a success rate corresponding to the collection of the first set of data;
logic, stored on the memory, for storing the first set of data and the first confidence factor in the memory; and
logic, stored on the memory, for reporting the first confidence factor in conjunction with the first set of data.

16. The computer programming product of claim 15, wherein the success rate is based upon the availability and completeness of the first set of data.

17. The computer programming product of claim 15, further comprising:
logic, stored on the memory, for recalculating the first confidence factor upon the collection of new data associated with the first set of data; and
logic, stored on the memory, for storing in a second memory the new data and the recalculated first confidence factor.

18. The computer programming product of claim 15, further comprising:
logic, stored on the memory, for collecting a second set of data associated with the business process;
logic, stored on the memory, for calculating a second confidence factor associated with the second set of data, wherein the second confidence factor is based upon a success rate corresponding to the collection of the second set of data;
logic, stored on the memory, for calculating a composite confidence factor associated with business data based upon the first and second confidence factors;
logic, stored on the memory, for storing the composite confidence factor in the memory; and
logic, stored on the memory, for reporting the composite confidence factor in conjunction with the business data based upon the first and second set of data.

19. The computer programming product of claim 18, wherein the logic for calculating the composite confidence factor comprises logic for multiplying the first confidence factor and the second confidence factor.

20. The computer programming product of claim 18, wherein the data is stored by a relational database management system and the first set of data corresponds to a first data table and the second set of data corresponds to a second table.
